(19) United States
(12) Patent Application Publication
(10) Pub. No.: US 2018/0000684 A1
(43) Pub. Date: Jan. 4, 2018

(54) MYOFASCIAL AND COMPRESSION RELEASE DEVICE

(71) Applicant: ARCROLLERS LLC, Austin, TX (US)

(72) Inventor: Gabriel Luke Burrell, Austin, TX (US)

(21) Appl. No.: 15/529,794

(22) PCT Filed: Nov. 19, 2015
(86) PCT No.: PCT/US15/61519

§ 371 Date: May 25, 2017

Related U.S. Application Data
(60) Provisional application No. 62/149,785, filed on Apr. 20, 2015.
(60) Provisional application No. 62/084,761, filed on Nov. 26, 2014.

(51) Int. Cl. A61H 15/00

(52) U.S. Cl. CPC A61H 15/00; A61H 2205/108; A61H 2205/106; A61H 2205/062; A61H 2201/1695; A61H 2015/0042; A61H 2201/1635; A61H 2201/0257; A61H 2201/0214; A61H 2201/0207; A61H 2201/164

(57) ABSTRACT

Described herein is a device and method for performing ischemic compression therapy to treat myofascial release. A method for performing ischemic compression therapy includes providing a device comprising two or more pressure rollers and an elastic compression band. The device is capable of being placed on a trigger point to form a loop configuration to provide 360° compression to the trigger point for a predetermined amount of time, such as a time sufficient to block blood flow to the trigger point.

### PRIORITY CLAIM

This application claims the benefit of U.S. Provisional Patent Application Ser. No. 62/149,785 filed Apr. 20, 2015, entitled MYOFASCIAL AND COMPRESSION RELEASE DEVICE, and U.S. Provisional Patent Application Ser. No. 62/084,761 filed Nov. 24, 2014, entitled MYOFASCIAL AND COMPRESSIVE RELEASE DEVICE THAT IS DESIGNED AID IN THE RELIEF AND RELEASE OF KNOTTED UP MUSCLES OF THE UPPER AND LOWER EXTREMITIES OF THE HUMAN BODY, the disclosures of which are incorporated herein by reference in their entireties.

### FIELD OF THE INVENTION

The invention relates generally to devices and methods for performing ischemic compression therapy and myofascial release. A device is applied to a trigger point for a predetermined amount of time to alleviate muscle contractions and muscle pain and to improve blood flow and lymphatic circulation.

### BACKGROUND

Many people suffer from myofascial pain and corresponding muscle pain, soreness, and tightness. Fascia is a thin, tough, and elastic connective tissue that provides support and protection to the body. Fascia surrounds the muscles, bones and joints and sometimes becomes restricted due to psychogenic disease, overuse, trauma, infectious agents, or inactivity. When fascia becomes restricted it can result in pain, muscle tension, and diminished blood flow. Myofascial release and ischemic compression are soft tissue therapies for the treatment of muscle immobility and pain. Myofascial release includes techniques such as massage or acupressure to release tight fascia. Often the technique is used by rolling the body on an elongate cylindrical foam roller. The pressure on the fascia can break down the restrictions and promote normal soft-tissue extensibility. This technique also improves flexibility, function, performance, and can reduce injuries.

Trigger point therapy relieves areas of muscle that are painful to palpation and can sometimes become thick, tough, and knotted. Therapy includes applying pressure to the trigger points, e.g., paraspinal muscles for upper and lower back pain or gluteus muscle for hip pain can relieve the muscle and promote relaxation and reduce pain.

Trigger point therapy is a massage technique that involves finding “trigger points” in the body and applying pressure to relieve symptoms of muscular pain and discomfort. A trigger point may also include a tight and tender spot in a muscle that refers pain (or “triggers” pain) to other areas of the body. Likewise, myofascial release is a massage therapy that involves finding tightened fascia in the body and applying pressure to alleviate the tension and discomfort. By applying pressure at the trigger point or the fascia, as the case may be, the trigger point or fascia is thereby “released.” The therapeutic results include reduction in pain and discomfort, and increased flexibility and overall promotion of health, well-being and fitness.

A myofascial rehabilitation device and method is desired that is easy to use by oneself and selectively applies pressure and compression to trigger point provide for stretching of the tissue by contacting the muscle. Therefore, in contrast to other devices, a device and method is provided that applies compression to 360° of a muscle tissue that can be applied without the need of someone else.

### SUMMARY

The present invention is directed towards a device and method for performing ischemic compression therapy and myofascial release therapy. The device is applied to a trigger point for a predetermined amount of time to alleviate muscle contractions and muscle pain and to improve blood flow and lymphatic circulation

A method for performing ischemic compression therapy includes providing a device comprising two or more pressure rollers and an elastic compression band. The pressure rollers are located on the elastic compression band. The device is placed on a trigger point and forms a loop configuration to provide 360° of compression to the trigger point for a predetermined amount of time, such as a time sufficient to block blood flow to the trigger point, and then the device is removed. When the device is removed, blood flow rushes back to the trigger point.

The method may include leaving the device at the trigger point for the predetermined time, or may include rolling the device over the trigger point for a predetermined amount of time. A predetermined amount of time may be up to 30 seconds, up to one minute, or up to five minutes. Alternatively, a predetermined amount of time may be a time sufficient to block blood flow to the trigger point to allow a rush a blood flow to occur once the device is removed.

The method includes providing a device that can provide for discontinuous 360° of pressure around a limb or other body structure, such as a shoulder or hip. The device is also capable of providing pressure to the trigger point through the entire device.

A device capable of performing ischemic compression includes two or more pressure rollers and an elastic compression band. The two or more pressure rollers and the elastic compression band are capable of forming a loop. In an embodiment, the pressure rollers have an outer surface and a bore formed through a middle, wherein the compression band is threaded through the bores of the pressure rollers. In another embodiment, the pressure rollers are moveable relative to the compression band.

In an embodiment, the device is adjustable. A connecting mechanism can secure ends of the elastic compression band to form a loop. The loop includes at least two pressure rollers and may include up to 20 or more pressure rollers. In an embodiment with multiple pressure rollers, multiple loops may be formed.

In yet another embodiment, the compression band includes a rigid straight portion and an elastic compression band.

The pressure rollers may be made from a variety of materials such as foam, foam rubber, high-density foam, polypropylene, other similar material, or a combination thereof. The pressure rollers are pliable or compressible. The pressure rollers may come in a variety of shapes such as a sphere, cone, ovoid, cube, pyramid, or cuboid. Still further, the pressure rollers may comprise projections and/or have a surface texture.

### BRIEF DESCRIPTION OF THE DRAWINGS

FIGS. 1a and 1b illustrate an example embodiment of the compression device;

FIG. 2 illustrates an alternative embodiment of the compression device;

FIGS. 3a-3c illustrate an example embodiment of the compression device on a treatment area selected from the forearm, arm, and shoulder;

FIGS. 4a-4b illustrate an example embodiment of the compression device on a treatment area selected from the leg, thigh, and foot;

FIGS. 5a-5b illustrate an example embodiment of the compression device comprising a connecting mechanism; and

FIG. 6 illustrates an example embodiment of the compression device comprising a rigid bar.

### DETAILED DESCRIPTION

Myofascial release is a soft tissue therapy for the treatment of skeletal muscle immobility and pain. Self-myofascial release refers to someone performing this therapy on oneself. Performing this therapy relaxes contracted muscle, improves blood flow and lymphatic circulation, and stimulates the stretch reflex in muscles. While fascia and corresponding muscles are the main target tissue areas of myofascial release, other tissues may be addressed, such as other connective tissue.

Ischemic compression is a therapy technique, where blockage of blood in an area of the body is deliberately made, so that a resurgence of local blood flow will occur upon release. Ischemic compression is applied to trigger points (trigger point therapy), where enough sustained pressure is applied to a trigger point with a tolerable amount of pain or discomfort, and as pain or discomfort is reduced, additional pressure is gradually given.

Myofascial trigger points, also known as trigger points, trigger sites, or muscle knots, are hyperirritable spots on the fascia surrounding skeletal muscle. They are associated with palpable nodule in taut bands of muscle fibers. The trigger point model states that unexplained pain frequently radiates from these points of local tenderness to broader areas, sometimes distant from the trigger point itself. Practitioners have identified reliable referred pain patterns which associate pain in one location with trigger points elsewhere. Compression of a trigger point may elicit local tenderness, referred pain, or local twitch response. The local twitch response is not the same as a muscle spasm. A muscle spasm refers to the entire muscle contracting, whereas the local twitch response also refers to the entire muscle, but only involves a small twitch and no contraction.

Common trigger points include, but are not limited to the lateral epicondyle or medial epicondyle of the forearm, the flexor halluces longus tip, flexor digitorumlongus tip, or the medial head of the gastrocnemius muscle of the leg, and the first metatarsal joint, the peroneal tendon, and the calcaneus of the foot.

A device as described herein comprises a pressure device and compression band that provides both compression and point pressure at the same time. The device can be used as an aid to solve the problems commonly associated with tight and knotted muscles in the upper and lower extremities. For example, the device performs myofascial release and compression simultaneously to provide relief for conditions such as tennis elbow, plantar fasciitis, Achilles tendonitis, carpal tunnel syndrome, shin splints, and other conditions.

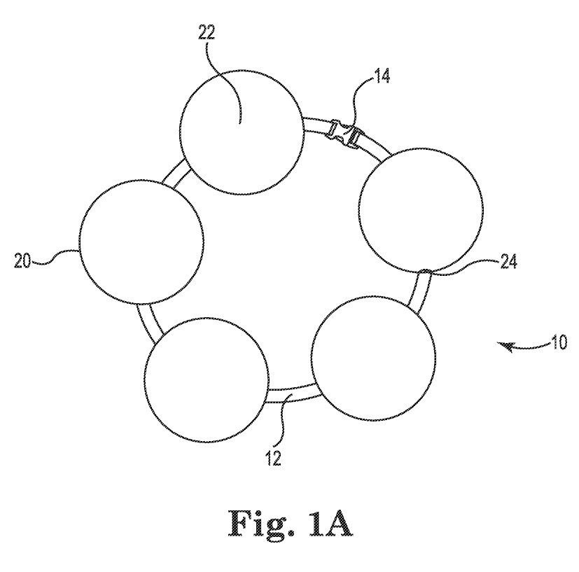

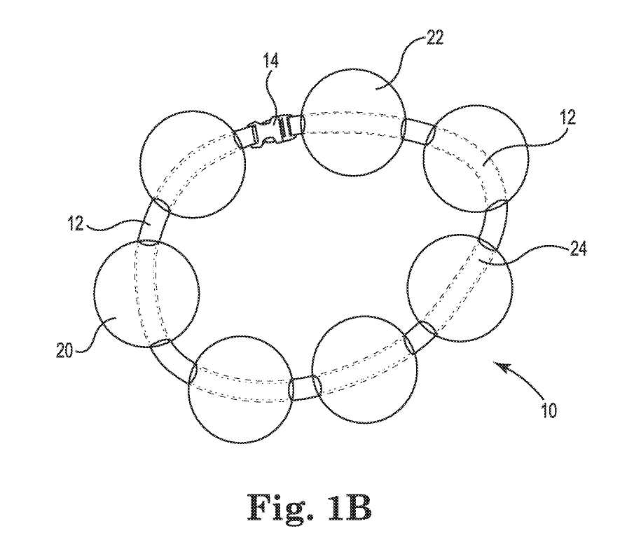

Referring to the figures, FIGS. 1a and 1b illustrate an example embodiment of compression device 10. Compression device 10 includes at least two pressure rollers 20 and compression band 12, for example FIG. 1a comprises five pressure rollers 20 and FIG. 1b comprises seven pressure rollers 20. The at least two pressure rollers 20 and compression band 12 are capable of forming a loop. In an embodiment as shown in FIG. 1b, compression band 12 forms a loop itself and is connected at band connection 14, and the pressure rollers 20 are threaded on the compression band 12. Pressure rollers 20 as illustrated in FIG. 1b comprises a bore 24 that extends through the entire pressure roller 20 (as shown by the dashed lines). The compression band 12 extends through the bore 24 as shown by the dotted lines.

When compression device 10 is in a loop formation, discontinuous 360° of compression therapy is capable of being applied to trigger points. The discontinuous 360° of pressure results from the pressure rollers 20 located spaced apart on the compression band 12. A loop may be formed by threading pressure rollers 20 on compression band 12 through bore 24 and connecting one end of the compression band 12 to the other end of the compression band 12 at band connection 14. In an alternative embodiment as shown in FIG. 1a, loop may be formed by compression band 12 and pressure rollers 20, wherein compression band 12 connects between and to each pressure rollers 20.

Pressure rollers 20 may have a diameter of about two inches. Alternatively, pressure rollers 20 may have a diameter of about one inch to about 4 inches. Bore 24 may have a diameter of about ⅛ inch to about ½ inch.

Pressure rollers 20 include an outer surface 22 and in an embodiment, a bore 24 extending through a middle section. FIG. 1b illustrates bore 24 extending through a middle section in a size sufficient to allow compression band 12 to extend therethrough. Compression band 12 and bore 24 may have a similar diameter so pressure rollers 20 do not move relative to each other. Alternatively, compression band 12 may have a smaller diameter than bore 24, so pressure rollers 20 are capable of moving relative to compression band 12. Allowing pressure rollers 20 to move relative to compression band 12 allows compression device 10 to roll over a trigger point.

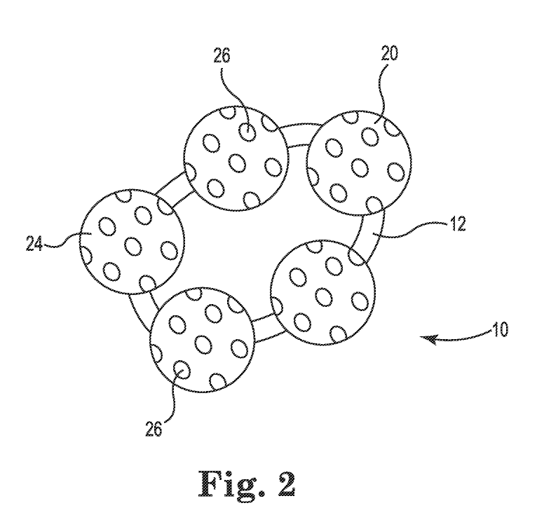

In an embodiment, outer surfaces 22 may include projections 26, as shown in FIG. 2. For example, projections 26 may be bumps, ridges, ribs, seams, spines, or other similar shape that is elevated from the outer surface 22. Projections 26 may be made from the same material as the pressure rollers 20, or may be made from a different material. Projections 26 are capable of providing additional pressure and compression to trigger points.

In another embodiment, compression band 12 extends through two or more pressure rollers 20 and is connected at band connection 14 to form a loop. Band connection 14 may alternatively be disconnected to form a line. In an alternative embodiment shown in FIG. 1a, compression band 12 is connected to pressure rollers 20 at opposing points on the outer surface 22.

A compression device 10 includes two or more pressure rollers 20. In an embodiment, compression device 10 may include more than two pressure rollers 20, such as five pressure rollers 20 or seven pressure rollers 20. Still further, compression device 10 may include more than seven pressure rollers 20. Pressure rollers 20 may be located equidistantly around compression band 12. Alternatively, pressure rollers 20 may be spaced around compression band 12 at unequal spacing.

The compression band 12 may be made from an elastic material, such as rubber tubing, latex rubber tubing, or non-latex rubber tubing. An exemplary material is capable of stretching up to five times its starting length, but goes back to its starting length without being misshapen. Differing resistance strength and elasticity of the compression band 12 may be provided to alter compression. An exemplary resistance strength is 2-30 pounds, for example 4-20 pounds, or 8-15 pounds. As the compression band 12 is stretched, the resistance provided by the compression band 12 is increased. An exemplary elasticity is less than 65,000 pounds per square inch (psi), for example 1,450-14,503 psi.

The pressure rollers 20 may be made from a variety of materials, including, but not limited to polypropylene, rubber, foam, foam rubber, high-density foam, and other like materials. A desirable material is one that has high compression strength, while also be pliable and compressible. For example, a high-density foam may have a compression of less than 20%, for example less than 10%. The material may be a material dense enough to provide pressure to the trigger point, while also contouring to the tissue.

In another embodiment, pressure rollers 20 are made from a material capable of being heated or cooled to provide additional therapy techniques. Example materials may be freezable and/or heatable gel material. Still further, pressure rollers 20 may be made from a washable material.

The compression device 10 provides soft tissue therapy for the treatment of skeletal muscle immobility and pain. Use of the compression device 10 on trigger points can help to relax contracted muscles, improve blood and lymphatic circulation, and stimulate the stretch reflex in muscles.

An example method of the present invention includes placing compression device 10 on a trigger point for a predetermined amount of time. A predetermined amount of time is a time capable of deliberately blocking blood flow to the area. After the predetermined amount of time has passed, the compression device 10 is removed from the trigger point so a resurgence of local blood flow occurs. A predetermined amount of time may be up to 30 seconds, 1 minute, two minutes, or three minutes.

Compression device 10 may be placed on a trigger point to provide continuous pressure and compression. Alternatively, compression device 10 may be rolled back and forth over trigger point or associated muscle. In a method of use, compression device 10 can be placed on or around a trigger point. Trigger points may be located on a limb or other part of the body, such as a shoulder or hip. The device is capable of providing dis-continuous or continuous 360° of pressure and compression around a limb or other body structure.

In an example method, compression device 10 is applied to and is allowed to remain on a trigger point to provide sustained pressure and compression. Alternatively, compression device 10 may be applied to a trigger point and rolled back and forth over the trigger point. Still further, a user may apply additional external pressure to the pressure roller 20 at the desired trigger point.

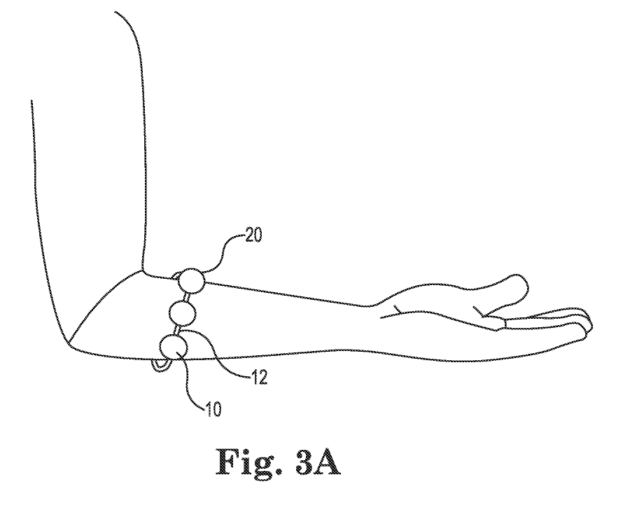

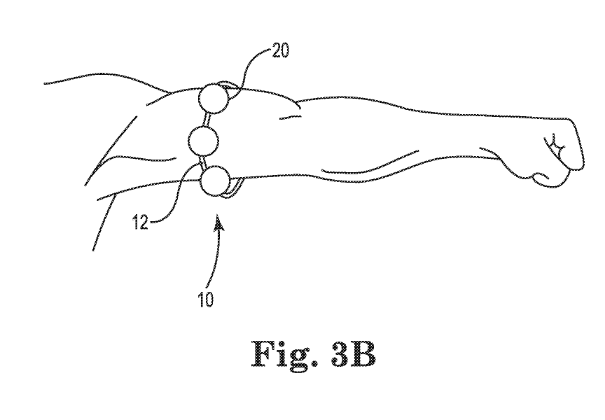

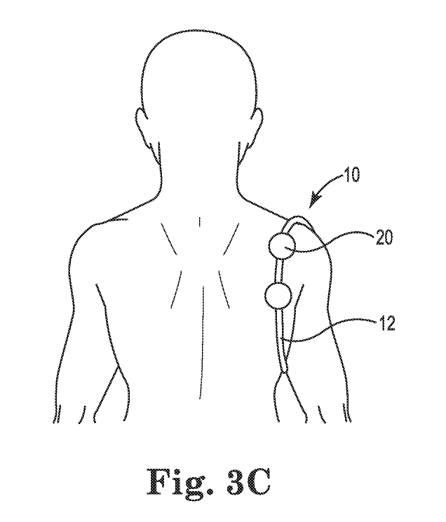

FIG. 3a illustrates a compression device 10 on a forearm, in which the compression device completely surrounds the limb to provide discontinuous 360° of compression and pressure. A method of performing ischemic compression includes applying pressure and compression to a trigger point, located for example at the lateral epicondyle or medial epicondyle, for a time sufficient to block local blood flow. Compression device 10 can also be rolled back and forth over a trigger point to provide compression and pressure to a large tissue area. Ischemic compression can help alleviate problems associated with tennis elbow, tendonitis, muscle pain or discomfort, pronator syndrome, radial tunnel syndrome, or other similar issues.

Compression device 10 can also be used in a similar fashion to the upper arm and shoulder area as shown in FIGS. 3b-3c. A user may use similar methods as described above regarding the upper arm. Trigger points on the upper arm may include for example, the triceps brachii, deltoid muscle, or the brachialis. Compression device 10 can also be stretched to apply pressure to the upper back and shoulder area. A shoulder or upper back trigger point, such as the subclavius area, scalenes, and latissimus dorsi, can be reached by stretching compression band 12 and pressure roller 20 to the desired trigger point, when the rest of the compression device 10 is located around the upper arm.

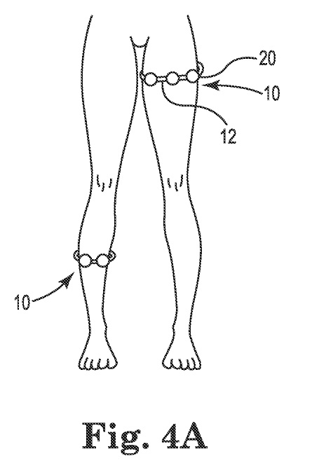

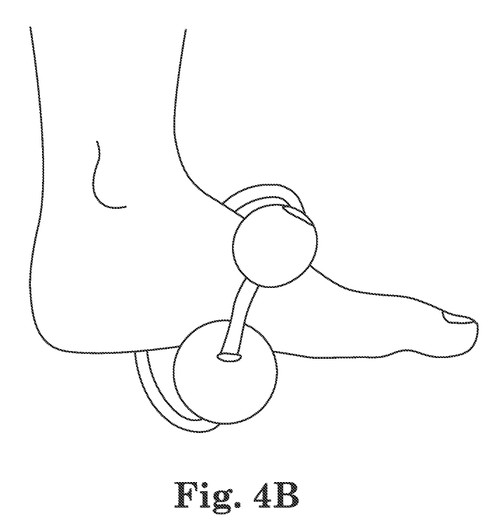

FIG. 4a illustrates a compression device 10 on a leg and thigh. Compression device 10 completely surrounds a leg or thigh to provide 360° of pressure or compression. A user can apply pressure to a specific trigger point on the leg, or roll compression device 10 up and down along leg or thigh to provide compression along the muscles and tendons. Example trigger points may include, but are not limited to, the flexor halluces longus tip, flexor digitorumlongus tip, or the medial head of the gastrocnemius muscle. Ischemic compression of the leg can help alleviate problems associated with shin splints, tendinitis, muscle sprain, muscle strains, and other similar injuries.

FIG. 4b illustrates compression device 10 surrounding the arch of the foot. Trigger points of the foot include, but are not limited to, the first metatarsal joint, the peroneal tendon, and the calcaneus. Injuries to be treated by the compression device 10 include, but are not limited to, plantar fasciitis, tendonitis, bunions, corns and calluses, and muscle sprains or strains. Pressure rollers 20 can be used to provide sustained pressure to one of these points for a predetermined period of time, such as a time sufficient to block local blood flow. Alternatively, compression device 10 may be rolled back and forth over the muscles of the foot.

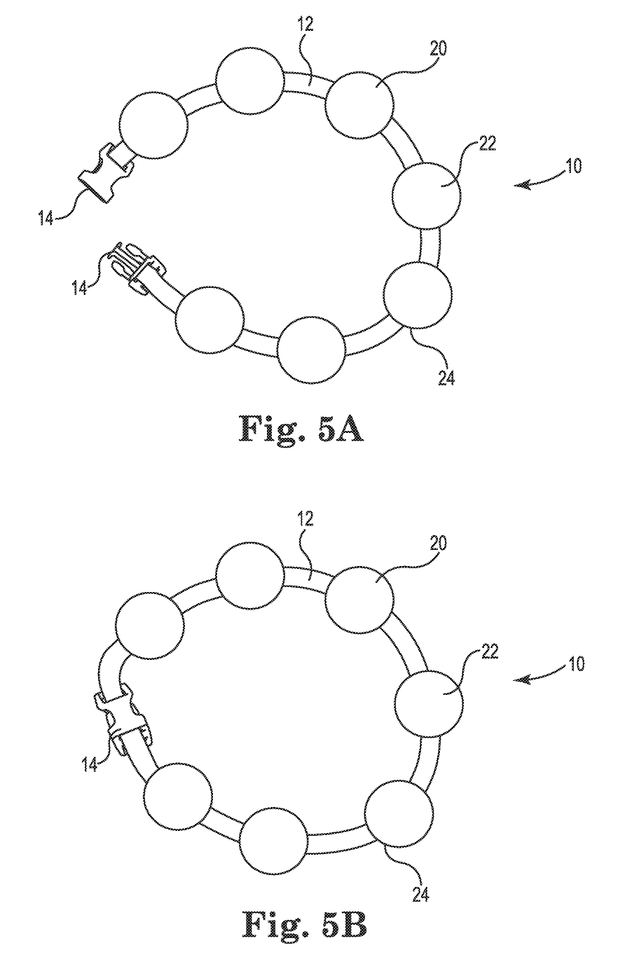

FIGS. 5a-5b illustrate compression device 10 comprising a releasable band connection 14. Band connection 14 may be releasable by means of a snap closure, Velcro®, tie, or other similar connecting mechanism. Band connection 14 can be disconnected when being placed into a treatment position and connected when compression device 10 is around the desired treatment position. In an embodiment, multiple devices 10 may be connected together at band connection 14 to create a larger compression device 10. Such a compression device 10 can be wrapped around a treatment area multiple times, for example two or more times.

In an embodiment, compression band 12 and pressure rollers 20 are separate. A user can add as many pressure rollers 20 to compression band 12 as desired and connect compression band 12 at and connection 14. The user can wrap compression device 10 around a treatment area at least one time, for example, three times, providing 1280° of pressure.

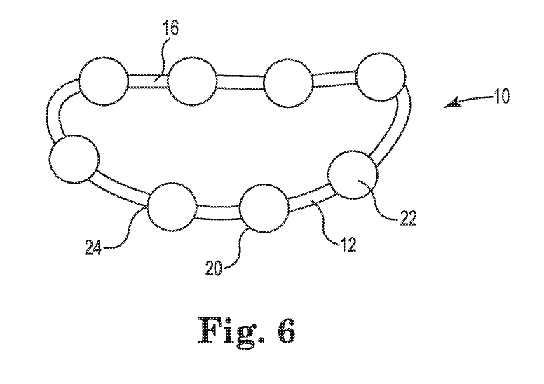

FIG. 6 illustrates an example embodiment of compression device 10 comprising a rigid bar 16. Rigid bar 16 may be straight or curved. Rigid bar 16 connects to compression band 12 at both ends to form loop. Compression device 10 including rigid bar 16 may also include band connection 14 at ends of compression band 12. Rigid bar 16 may be up to or more than 8 inches, or up to 36 inches long. Rigid bar 16 and bore 24 may have a similar diameter so pressure rollers 20 do not move relative to each other. Alternatively, rigid bar 16 may have a smaller diameter than bore 24, so pressure rollers 20 are capable of moving relative to rigid bar 16. Allowing pressure rollers 20 to move relative to rigid bar 16 allows compression device 10 to roll over a trigger point.

Example of devices that may be useful to provide ischemic compression and myofascial release are described in U.S. Pat. No. 8,821,352 and U.S. Pat. App. Nos. 2014/0259422; 2013/0085426; 2012/0065557; 2012/0035029, the entireties of these documents are incorporated herein by reference.

It should be understood, of course, that the foregoing relates to exemplary embodiments of the invention and that modifications may be made without departing from the spirit and scope of the invention as set forth in the following claims.

1. A method of performing ischemic compression therapy, comprising:
providing a device comprising two or more pressure rollers and an elastic compression band, wherein the pressure rollers are located on the elastic compression band,
placing the device on a trigger point, wherein the device forms a loop configuration,
providing compression to the treatment area for a predetermined amount of time, and
removing the device from the trigger point.

2. The method of claim 1, wherein providing compression to the treatment area comprises rolling the device over the treatment area.

3. The method of claim 1, wherein the device provides at least 360° of discontinuous pressure around a limb or other body structure.

4. The method of claim 1, wherein the device can be wrapped around a treatment area at least one time.

5. The method of claim 1, wherein compression is provided to the treatment area for a time up to one minute.

6. The method of claim 1, wherein compression is provided to the treatment area for a time up to two minutes.

7. The method of claim 1, wherein the elastic compression band provides pressure to the trigger point throughout the entire device.

8. The method of claim 1, wherein the predetermined amount of time is a time sufficient to block blood flow to the trigger point.

9. A device capable of performing ischemic compression,
the device comprising two or more pressure rollers, and
an elastic compression band, wherein the two or more pressure rollers and the elastic compression band forms a loop.

10. The device according to claim 9 comprising a rigid bar comprising a first and second end, each end connected to the elastic compression band to form the loop.

11. The device according to claim 9, wherein the elastic compression band comprising a connecting mechanism, wherein the connecting mechanism can be disconnected and reconnected.

12. The device of claim 11, wherein the connecting mechanism is a snap closure, Velrco®, tie, buckle, or other similar mechanism.

13. The device according to claim 9, wherein the pressure rollers are made from a material selected from foam, foam rubber, high-density foam, polypropylene, and other similar material.

14. The device according to claim 9, wherein the pressure rollers comprise a shape selected from the group consisting of a sphere, cone, ovoid, cube, pyramid, and cuboid.

15. The device according to claim 9, wherein the pressure rollers are pliable or compressible.

16. The device according to claim 9, wherein the pressure rollers comprise projections or have a surface texture.

17. The device according to claim 9, wherein the pressure rollers have an outer surface and a bore formed through a middle and wherein the compression band is threaded through the bore of the pressure rollers.

18. The device according to claim 9, wherein the pressure rollers are moveable relative to the compression band.

19. A method of treating muscle pain comprising
identifying a trigger point
applying pressure to the trigger point
releasing the pressure from the trigger point after a sufficient period of time.
